(19) United States
(12) Patent Application Publication
(10) Pub. No.: US 2006/0129407 A1
(43) Pub. Date: Jun. 15, 2006

(54) Voice recognition doorlock apparatus

(76) Inventor: Sang-Won Lee, Incheon-city (KR)

Correspondence Address: HARNESS, DICKEY & PIERCE, P.L.C., P.O. BOX 8910, RESTON, VA, 20195, US

(21) Appl. No.: 10/530,010

(22) PCT Filed: Oct. 1, 2003
(86) PCT No.: PCT/KR03/02022

§ 371 Date: Oct. 3, 2005

(30) Foreign Application Priority Data
Oct. 10, 2002 (KR) 10-2002-0059860

(51) Int. Cl. G10L 21/00

(52) U.S. Cl. 704/275

(57) ABSTRACT

A voice recognition doorlock apparatus includes a control unit for controlling the lock state of a doorlock to be unlocked by a doorlock driving unit only when a currently inputted digital voice signal matches a specific voice signal stored in first storing unit and matches input key signals stored in second storing unit.

### TECHNICAL FIELD

The present invention relates to a doorlock and, more particularly, a voice recognition doorlock apparatus for controlling doorlock by means of voice authentication.

### BACKGROUND ART

Generally, the doorlock is that a door is opened/closed by a mechanical method. A key is inserted into a key insert hole of the doorlock, and the inserted key is rotated to open a door. A disadvantage of the doorlock using a key is that if the key is lost, the door cannot be opened/closed. Another disadvantage is that an outsider may use a key without permission to trespass on a home or office. Although the key is not used without permission, a skilled in the art can readily unlock the doorlock to open a door.

To overcome these disadvantages, button-type digital doorlock and fingerprint identification doorlock have been suggested. In case of the button-type digital doorlock, buttons are pressed to set a password. If the set password is divulged to an outsider, it is hard to prevent his/her trespass. In case of the fingerprint identification doorlock, high-cost apparatuses are used to recognize and process fingerprints. Thus, lots of installation cost is required.

### DISCLOSURE OF INVENTION

According to the present invention, a voice recognition doorlock apparatus comprises first input means, having a plurality of input keys, for outputting input key signals corresponding to the input keys whenever the input keys are pressed; second input means for receiving an analog voice signal and converting the received analog voice signal to a digital voice signal; voice analyzing means for receiving the digital voice signal to extract a specific voice signal from the digital voice signal in a registration mode and storing the extracted specific voice signal in first storing means as an ID of a registration-desiring user; control means for storing input key signals which is inputted through the first input means in the registration mode and indicates a password; and doorlock driving means for locking or unlocking a doorlock according to the control of the control means. The voice analyzing means determines whether a currently inputted digital voice signal matches the specific voice signal stored in the first storing means to generate a first flag signal, as a determining result. When the currently inputted voice signal matches the specific voice signal stored in the first storing means, the control means determines whether the input key signals currently inputted as the password matches the input key signals stored in the second storing means in response to the first flag signal. When the currently input key signals matches the input key signals stored in the second storing means, the control means control the door lock to be unlocked by the doorlock driving means.

The voice recognition doorlock apparatus further comprises voice generating means for generating a voice signal according to the control of the control means; and first sensing means for sensing an open/close state of a door and transmitting the sensing result to the control means. A part of the input keys are disposed outside a door, and the other input keys are disposed inside the door. The voice recognition doorlock apparatus further comprises second sensing means for sensing an illegal handling of the input keys disposed inside the door and transmitting the sensing result to the control means. When the input keys disposed inside the door are not illegally handled by a person, the control means controls the voice generating means to output a warning sound in response to the sensing result transmitted from the second sensing means.

The voice analyzing means includes a dual tone multi-frequency (DTMF) generator. When the control means generates a second flag signal indicating that the door is forcibly opened, the DTMF generator generates a MTMF signal. The voice recognition doorlock further comprises radio transmitting means for transmitting the DTMF signal. The input keys include an interphone key. When the interphone key is pressed, the control means controls the voice generating means to enable a user to output a predetermined voice message signal.

When the interphone key is pressed, the control means controls the voice analyzing means, the voice generating means, and the first input means to enable the user to a message. The input keys include a record key. When the record key is pressed, the control means controls the voice analyzing means, the voice generating means, and the first input means to enable the user to a message.

### BRIEF DESCRIPTION OF DRAWINGS

FIG. 1 is a block diagram of a voice recognition doorlock apparatus according to the present invention;

FIG. 2 is a flowchart for explaining the registration procedure of the voice recognition doorlock apparatus according to the present invention;

FIG. 3 is a flowchart for explaining the authentication procedure of the voice recognition doorlock apparatus according to the present invention;

FIG. 4 is a flowchart for explaining a door bell and a message recoding function of the voice recognition doorlock apparatus according to the present invention;

FIG. 5 is a flowchart for explaining a family message recording function of the voice recognition doorlock apparatus according to the present invention; and

FIG. 6 shows the contents of messages used in FIG. 2 to FIG. 4.

### BEST MODE FOR CARRYING OUT THE INVENTION

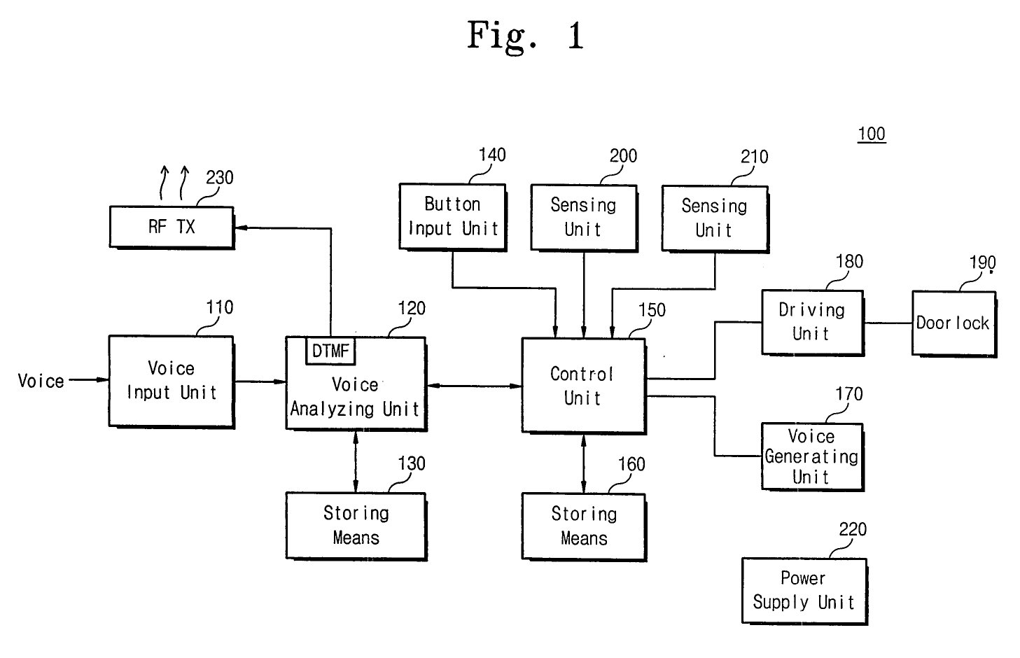

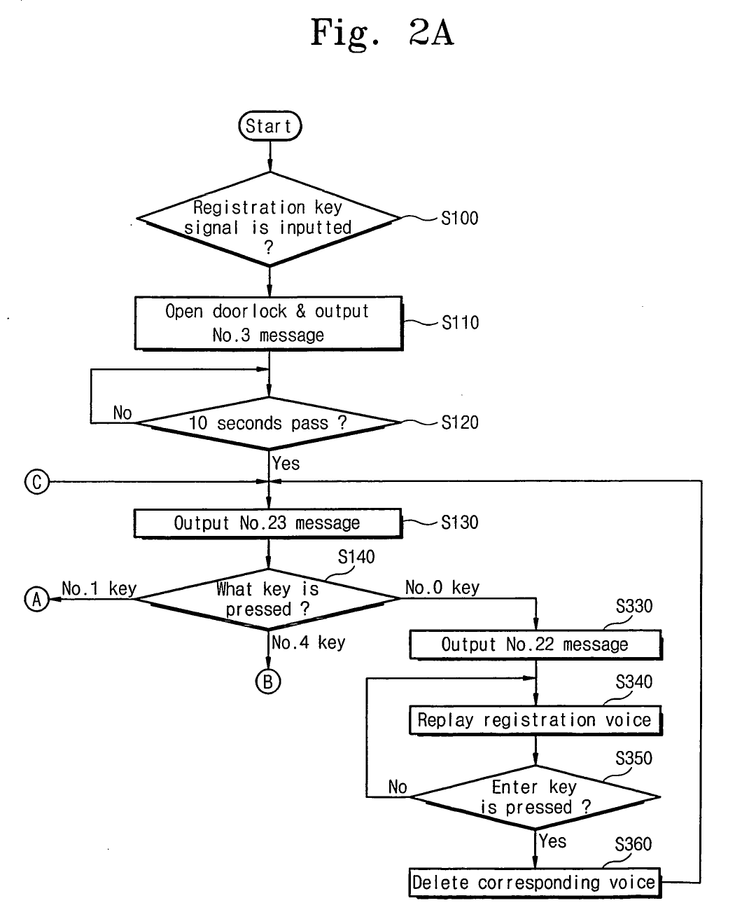

Referring to FIG. 1, a voice recognition doorlock apparatus 100 according to the present invention includes a voice input unit 110, a voice analyzing unit 120, first storing means 130, a button input unit 140, a control unit 150, second storing means 160, a voice generating unit 170, a driving unit 180, a doorlock 190, first and sensing units 200 and 210, a power supply unit 220, and a radio transmitter (RFTX) 230. The supper supply unit 220 has a battery and supplies a power to the voice recognition doorlock apparatus 100.

The voice input unit 110 receives an analog voice signal and converts the received analog signal to a digital voice signal. Although not shown in this figure, the analog input unit 110 includes a microphone (or mike) for receiving an analog voice signal and an analog-to-digital converter for converting an analog voice signal to a digital voice signal. However, it is apparent to a person skilled in the art that the voice input unit 100 may be variously designed using a variety of methods according to designers and applications. The voice analyzing unit 120 extracts a specific voice signal from the digital voice signal outputted from the voice input unit 110 and stores the extracted voice signal in the first storing means 130. Particularly, the voice analyzing unit 120 extracts the characteristic voice of a registration-desiring person in response to the control of the control unit 150 in a registration mode. By the control of the voice analyzing unit 120, the extracted specific voice signal is stored in the first storing means 130. The voice analyzing means 120, in a standby mode, determines whether a currently inputted digital voice signal matches a specific voice signal stored in the first storing means 130 and outputs the determination result to the control unit 150. The first storing mean 130 has a non-volatile memory (e.g., flash memory, EEPROM, etc.) for storing the intrinsic specific voice signal of the registration-desiring person.

Continuously referring to FIG. 1, the button input unit 140 includes a plurality of input keys (not shown). For example, the input keys may include number keys, a register key, a record key, a replay/pause key, an open/close key, an enter key, an interphone key, and so forth. A part of the input keys (e.g., the number keys, the enter keys, and interphone key) are disposed outside a door, and the other keys (e.g., the record key, the replay/pause key, the open/close key, the register key, etc.) are dispose inside the door. These keys will be explained in detail later.

The control unit 150 is connected to the voice analyzing unit 120, the button input unit 140, the second storing means 160, and the sensing units 200 and 210, the driving unit 180, and the voice generating unit 170. The control unit 150 controls a registration procedure, an authentication procedure, and a message record/replay procedure in response to a key signal corresponding to a pressed one of the input keys of the button input unfit 140. For example, in a registration mode for registering a user's ID, a personal password, and a family password, the control unit 150 makes the voice analyzing unit 120 extract a specific voice signal (to be used as a user's ID) from the inputted digital voice signal in response to a registration signal (which is a signal generated when a registration key is pressed) inputted through the button input unit 140. In the registration mode, the control unit 150 stores the personal password/family password, inputted through the button input unit 140, in the second storing unit 160. In a standby state, the control unit 150 determines whether key signals inputted through the button input unit 140 as a password matches the personal password/family password stored in the second storing means 160.

The driving unit 180 locks or unlocks the doorlock 190 in response to the control of the control unit 150. For example, when a currently inputted digital voice signal matches a specific voice signal stored in the first storing means 130 and key signals inputted through the button input unit 140 as a password match a personal password stored in the second storing means 160, the control unit 150 outputs doorlock unlocking information to the driving unit 180. The driving unit 180 unlocks a lock state of the doorlock 190 in response to the doorlock unlocking information from the control unit 150. The first sensing unit 200 senses whether a door is opened or closed and transmits the sensing result to the control unit 150. The control unit 150 controls the voice generating unit 170 to output a needed voice message according to the sensing result. The second sensing unit 210 senses whether input keys disposed inside the door are illegally handled and transmits the sensing result to the control unit 150. For example, the second sensing unit 210 may have an infrared sensor for sensing whether the input keys disposed inside the door are pressed by a person or a tool handled by an outsider.

As shown in FIG. 1, the voice analyzing unit 120 includes a dual tone multi-frequency generator (hereinafter referred to as “DTMF generator”). When the control unit 150 informs the fact that a door is forcibly opened, the DTMF generator of the voice analyzing unit 120 generates a DTMF signal in response to the information of the control unit 150. The generated DTMF signal is to be transmitted to the outside (e.g., guardroom) through the radio transmitter (RFTX) 230. The forcible opening of the door may be sensed by a variety of methods (e.g., sensing an excessive movement of a door knob).

According to the above-described voice recognition doorlock apparatus 100, in order to unlock the lock of the doorlock, a voice signal of a person wanting to go in and out must match a registered specific voice signal and an inputted password must match a stored password. That is, a door is opened by combination of voice-based authentication and password-input authentication (or a dual security system using voice input and button-type password input is realized) to prevent the trespass of outsiders.

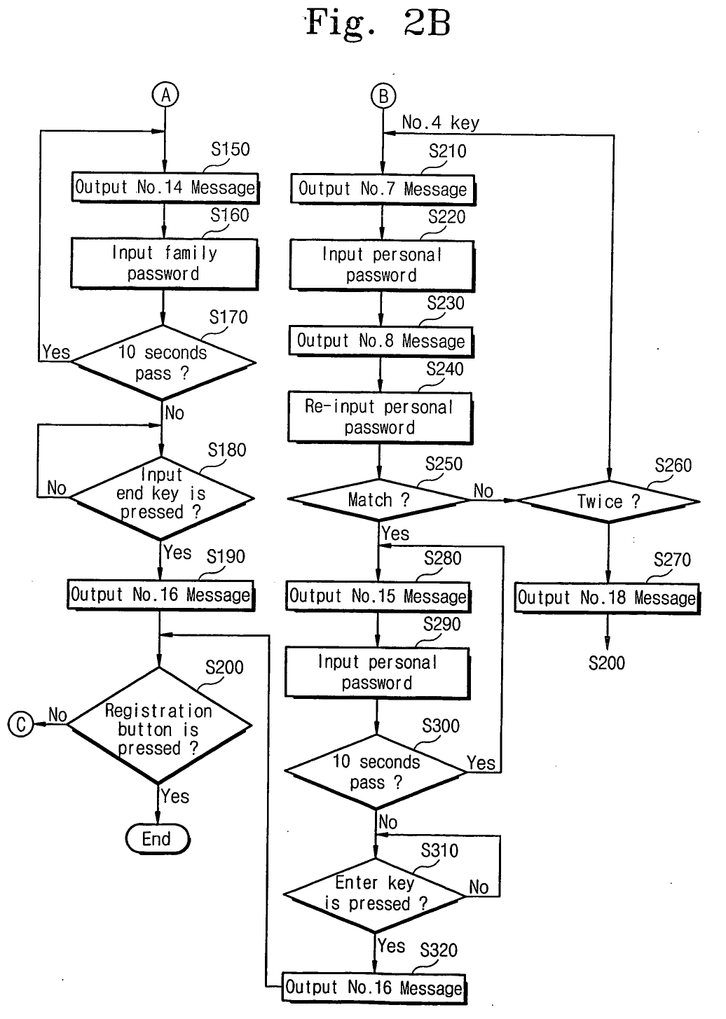

A registration procedure of the voice recognition doorlock apparatus according to the present invention will now be described with reference to FIG. 2.

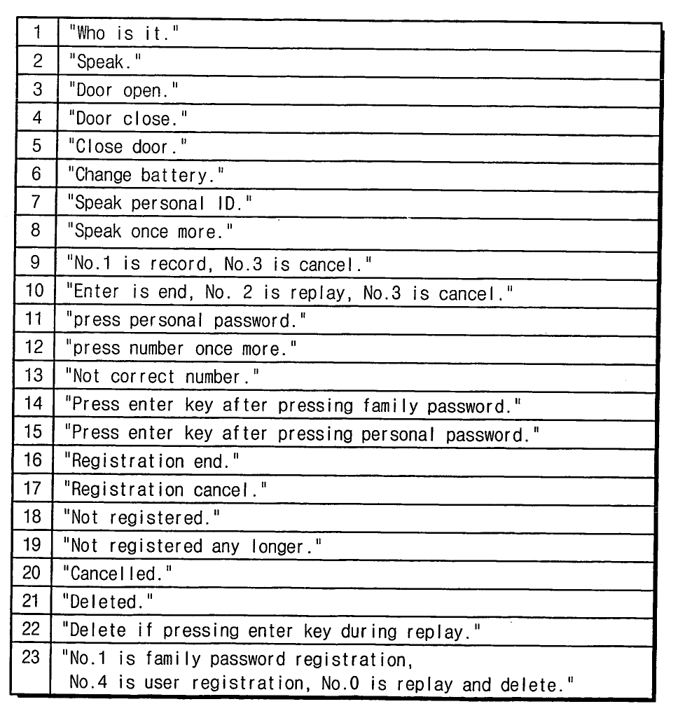

To register a user's ID and personal/family password, the user (or a registration-desiring person) must press a register key of a button input unit 140. When a registration key signal (or registration signal) is inputted (S100), a control unit 150 controls a driving unit 180 in response to a registration signal. According to this control, the control unit 180 unlocks a lock state of a doorlock 190. After the lock state of the doorlock 190 is unlocked, the control unit 150 controls a voice generating unit 170 to output a voice signal of a third message (see FIG. 6, “door open”). This procedure is carried out in step S110. After the third message is outputted, it is determined whether predetermined time (e.g., 10 seconds) passes (S120). If the predetermined time passes, a 23rd message (see FIG. 6, “No. 1 is family password registration, No. 4 is user registration, and No. 0 is replay and delete”) is outputted (S130).

In step S140, the control unit 150 checks what password is inputted through the button input unit 140. The control unit 150 performs a procedure to register a family password when No. 1 key is pressed, performs a procedure to register a personal ID and password when No. 4 key is pressed, and performs a procedure to replay/delete a registered personal ID. This will now be described more specifically.

In case that the No. 1 key is pressed, the voice generating unit 170 outputs a 14th message (see FIG. 6, “press enter key after pressing family password”) under the control of the control unit 150. The family password is inputted through the button input unit 140. When the family password is set, successive keys must be pressed within predetermined time (e.g., 10 seconds). If the successive keys are pressed over 10 seconds, this routine returns to step S150 to re-input a family password from the start. This procedure is conducted through steps S160 and S170. The inputted family password is stored in second storing means 160 according to the control of the control unit 150. If the successive keys are pressed within 10 seconds, the control unit 150 determines whether the enter key is pressed as an input end key (S180). If so, the voice generating unit 170 outputs a 16th message (see FIG. 6, “registration end”) according to the control of the control unit 150 (S190). In step S200, the control unit 150 determines whether a registration signal is inputted. In case that the registration key is pressed once, the registration procedure is completed. In case that the registration key is not pressed, this routine advances to step S150 to replay or delete the registered family password and to input a personal ID and password.

In case that No. 4 key is pressed in step S140, the control unit 150 controls the voice generating unit 170 to output a 7th message (see FIG. 6, “speak personal ID”) (S210). In this case, the voice analyzing unit 120 makes preparation for analyzing a digital voice signal from the voice input unit 110 by means of communication with the control unit 150. A user speaks a registration-desiring personal ID with his/her voice according to a voice message (S220). An analog voice signal, as a personal ID, is converted to a digital voice signal through the voice input unit 110. The digital voice signal is transmitted to the voice analyzing unit 120. The voice analyzing unit 120 extracts a specific voice signal from the digital voice signal. If an 8th message (see FIG. 6, “speak once more”) is outputted (S230), the user speaks the personal ID once more (S240).

In step S250, the voice analyzing unit 120 determines whether corresponding digital voice signals match the personal ID inputted twice. If not match, it is determined whether a personal ID input procedure is repeated twice (S260). If not repeated twice, this routine advances to step S210. If repeated twice, after an 18th message (see FIG. 6, “not registered”) is outputted (S270), this routine advances to step 5200. In step S250, when the digital voice signals inputted twice match each other, the control unit 150 controls the voice generating unit 170 to output a 15th message (see FIG. 6, “press enter key after pressing personal password”). The personal password is inputted through the button input unit 140. When the personal password is set, successive keys must be pressed within predetermined time (e.g., 10 seconds). If the predetermined time passes, this routine advances from start to step S280 to input a personal password. This procedure is performed in steps S290 and S300. The inputted personal password is stored in the second storing means 160 according to the control of the control unit 150. If the successive keys are pressed within 10 seconds, the control unit 150 determines whether the enter key is pressed as an input end key (S310). If so, the voice generating unit 170 outputs a 16th message (see FIG. 6, “registration end”) according to the control of the control unit 150 (S320). Afterwards, this routine advances to step S200 to determine whether a registration signal (which is a signal generated when a registration key is pressed) for completing the registration procedure is inputted. In case that the registration key is pressed once, the registration procedure is completed. In case that the registration key is not pressed, this routine advances to step S130 to replay or delete the registered family password/personal password and to input a personal ID and password.

In case of No. 0 key is pressed in step S140, the control unit 150 controls the voice generating unit 170 to output a 22nd message (see FIG. 6, “delete if pressing enter key during replay”). After the 22nd message is outputted, a voice signal corresponding to the registered personal ID is regenerated (S340). The control unit 150 determines whether the enter key is inputted during replay(S350). If not so, registered voice signals are all sequentially replayed. If so, after deleting the corresponding voice (S360), this routine advances to step S130. In case that registered voices are all replayed, this routine advances to step S130 irrespective of pressing the enter key.

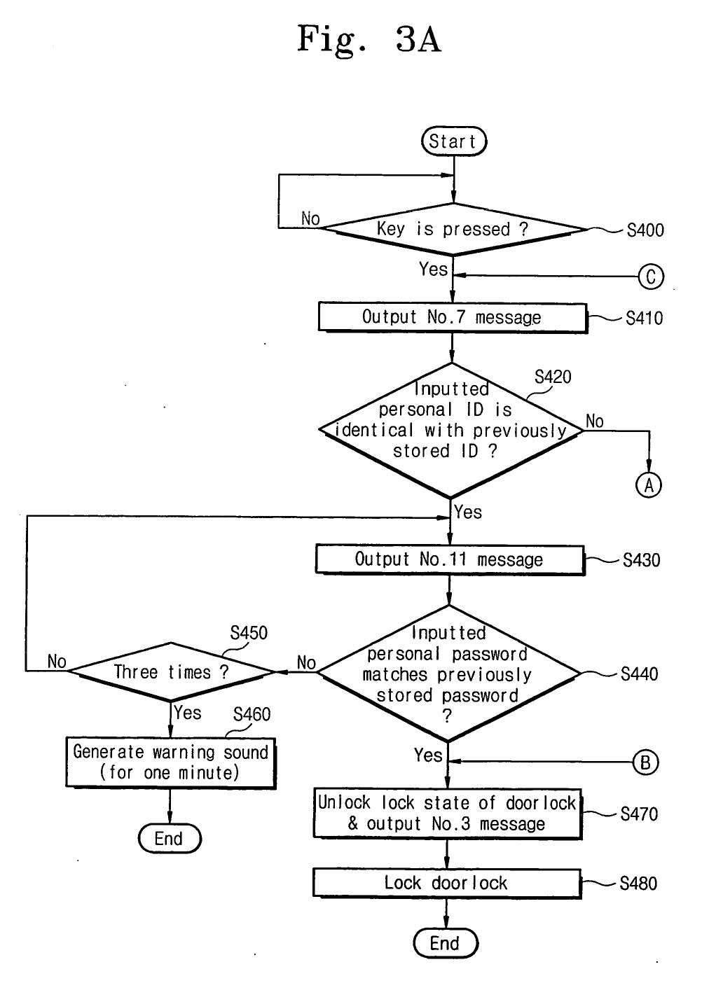

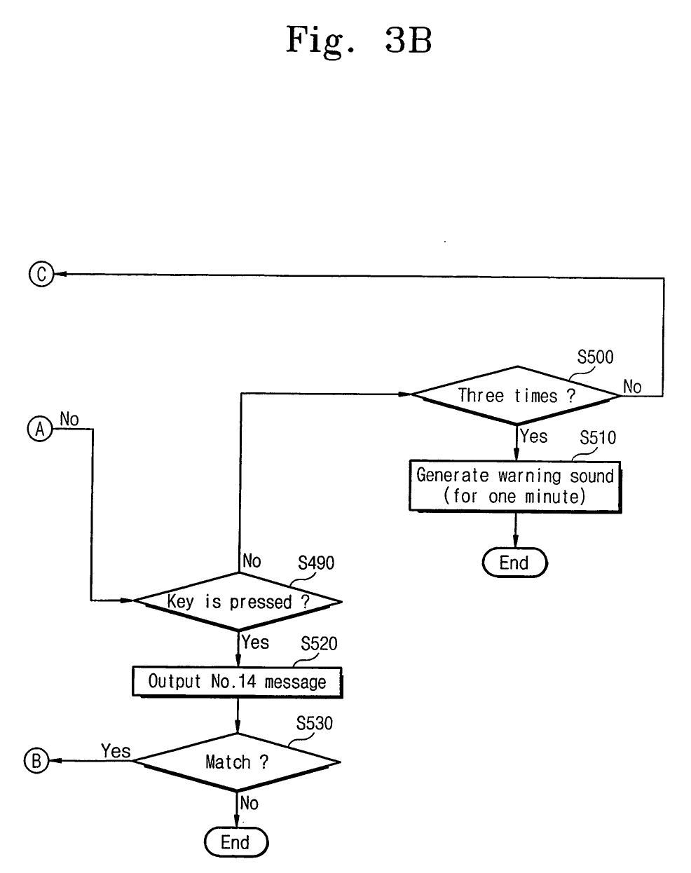

An authentication procedure of the voice recognition doorlock apparatus according to the present invention will now be explained with reference to FIG. 3. To open a door after going out, an authentication procedure, which will be explained hereinbelow, must be needed.

The controller 150 determines whether any key is pressed (S400). If any key is pressed, a 7th message (see FIG. 6, “speak personal ID”) is outputted through the voice generating unit 170. In this case, the voice analyzing unit 120 makes preparation for analyzing a digital voice signal from the voice input unit 110 by means of communication with the control unit 150. A person wanting to go in and out speaks his/her ID according to the output of a message. An analog voice signal, as a personal ID, is converted to a digital voice signal through the voice input unit 110. The voice analyzing unit 120 determines whether a currently inputted digital voice signal matches a specific voice signal stored in the first storing means 130 (S420). If so, an 11th message (see FIG. 6, “press personal password”) is outputted (S430). Afterwards, the control unit 150 determines whether the inputted personal password matches the registered personal password stored in the second storing means 160 (S440).

If the inputted personal password does not match the registered personal password, the control unit 150 determines whether an input procedure is repeated three times or more (S450). If not so, this routine advances to step S430. If so, after generating a warning sound (S460) for predetermined time (for example, one minute), the authentication procedure is completed. If the inputted personal password matches the registered personal password, the control unit 150 controls the driving unit 180 to unlock the lock state of the doorlock 190 and controls the voice generating unit 170 to output a 3rd message (see FIG. 6, “door open”) (S470). If the door is closed, the doorlock 190 is automatically locked (S480) and the authentication procedure is completed.

If the inputted personal ID does not match a previously stored ID in step S420, it is determined whether any key is pressed (S490). If not so, it is determined whether the personal ID is repeated three times (S500). If the personal ID is not repeated three times, this routine advances to S410. If the personal ID is repeated three times, after a warning sound is outputted for predetermined time (for example, one minute) (S510), the authentication procedure is completed. If any key is pressed in step S490, a 14th message (see FIG. 6, “press enter key after pressing family password”) is outputted (S520). The control unit 150 determines whether the family password inputted according to the output of the message matches a previously stored password (S530). If so, the procedure advances to step S470. If not so, the authentication procedure is completed.

The steps S490, S520, and S530 are used in case that a personal wants to go in and out by authenticating only a family password in emergency (e.g., it is hard to authenticate a personal password because a personal gets hoarse or suffers from other symptoms).

According to the above authentication procedure, the security of a home or office can be guaranteed. Further, the inconvenience of carrying a key such as mechanical doorlock and the apprehension of divulging a doorlock password are attenuated to enhance the security of a home or office.

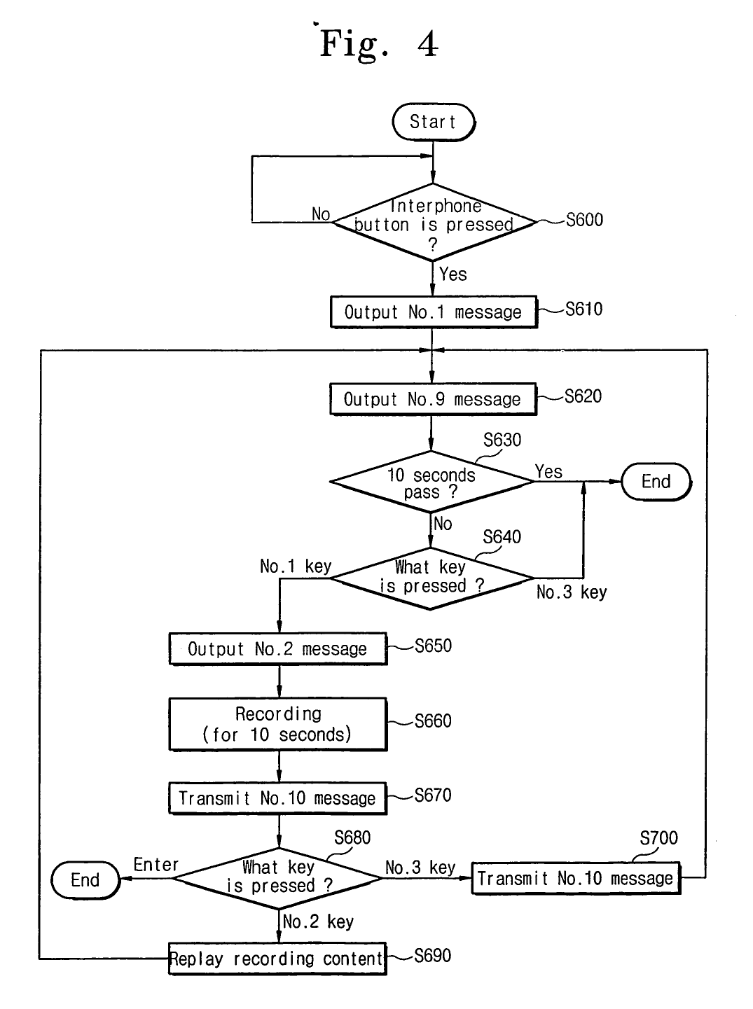

An interphone function and a message recording function of the voice recognition apparatus 100 according to the present invention will now be described with reference to FIG. 4. The voice recognition apparatus 100 offers an interphone function. Since the interphone function responds to the visit of outsiders, an immediate action is not needed. Further, the voice recognition apparatus offers the message recording function to record the message that a visor wants to transmit. The interphone and message recording functions will now be described more fully hereinbelow.

The control unit 150 determines whether an interphone key is pressed (S600). This is achieved by determining whether a key signal corresponding to the interphone key is inputted through the button input unit 140. If the interphone key signal is inputted, the control unit 150 controls the voice generating unit 170 to output a 1st message (see FIG. 6, “who are you”). After predetermined time, the control unit 150 controls the voice generating unit 170 to output a 9th message (see FIG. 6, “No. 1 is record, No. 2 is cancel”). If predetermined time (for example, 10 seconds) passes, the procedure is completed. If not so, it is checked what key is pressed (S640). If No. 3 key is pressed, the procedure is completed.

If the No. 1 key is pressed, the voice generating unit 170 outputs a 2nd message (see FIG. 6, “speak”) according to the control of the control unit 150 (S650). The message of a visitor is recorded during predetermined time (for example, 10 seconds) (S660), which is achieved according to the following procedure. For example, the message will be stored in the first storing means 130 under the control of the voice analyzing unit 120. After a 10th message (see FIG. 6, “enter key is end, No. 2 key is replay, and No. 3 key is cancel”) is outputted (S670), it is determined checked what key is pressed (S680). This is achieved through the control unit 150. In case that the enter key is pressed, the procedure is completed. In case that No. 3 key is pressed, after a 20th message (see FIG. 6, “cancelled”) is outputted (S700), this routine advances to step S620. In case that No. 2 key is pressed, after recording content is replayed (S690), this routine advances to step S620.

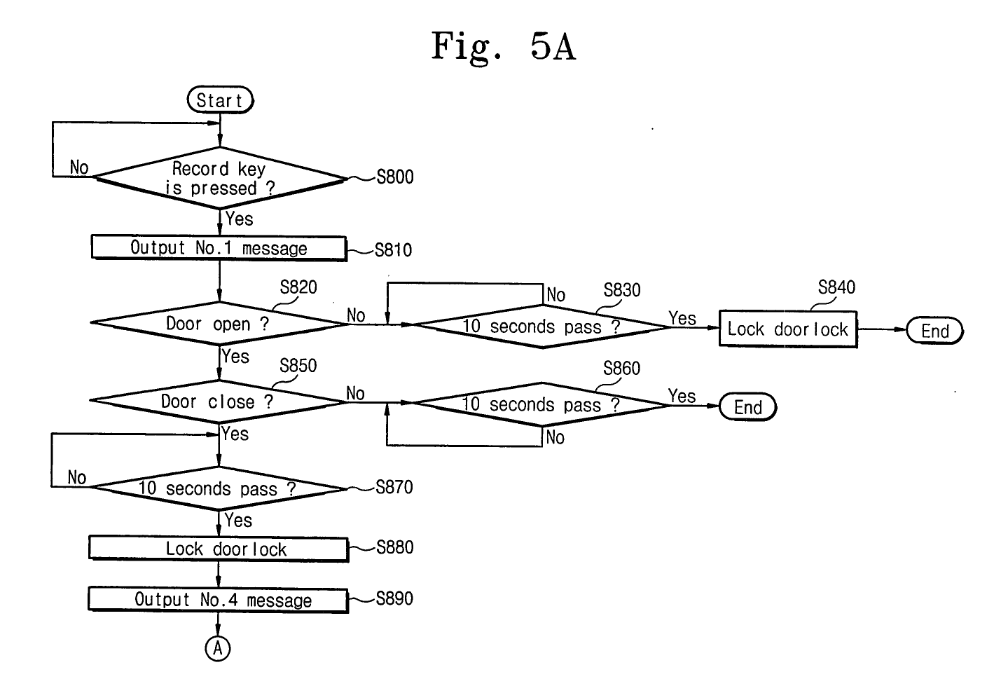

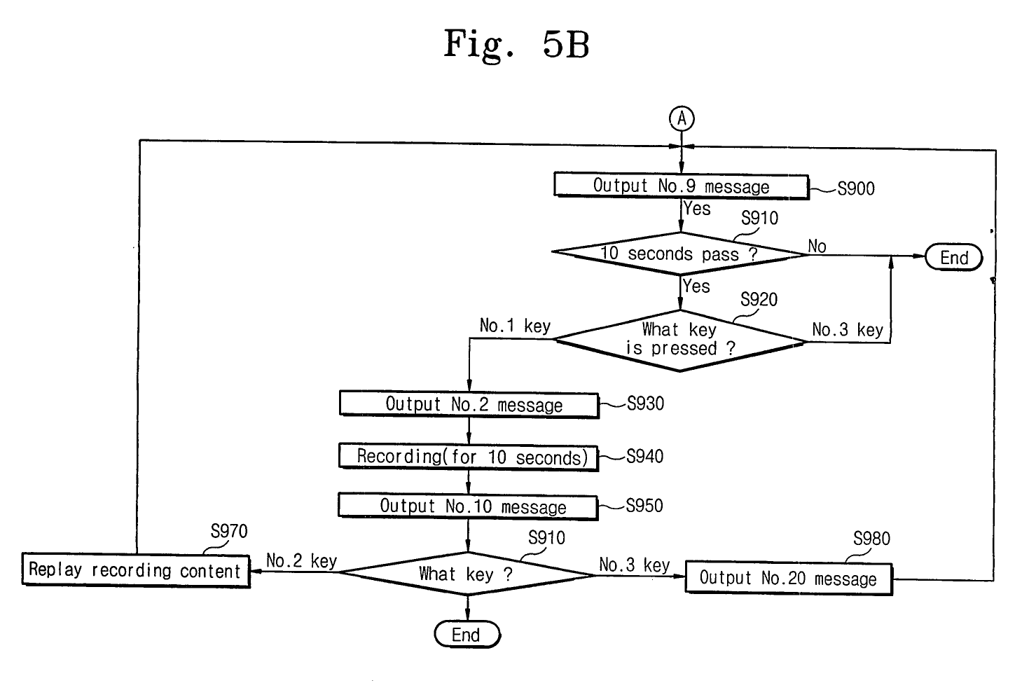

A family message recording function of the voice recognition doorlock apparatus 100 according to the present invention will now be described with reference to FIG. 5. The voice recognition doorlock apparatus 100 offers a family message recording function to allow a person, who goes in after another personal goes out, to record a message.

Since the family message recording function leads to user's convenience in a home or office, a message to be transmitted to a next user or a message recorded by a visitor are transmitted to meet user's desire. The control unit 150 determines whether a record key of the button input unit 140 is pressed (S800). If so, the control unit 150 controls the driving unit 180 to unlock a lock state of the doorlock 190 and controls the voice generating unit 170 to output a 3rd message (see FIG. 6, “door open”) (S810). It is determined whether the door is opened (S820). This is performed through the first sensing unit 200 and the control unit 150.

If the door is not opened for the predetermined time, after the doorlock 190 is closed (S840), the procedure is completed. If the door is opened, it is determined whether the door is closed after predetermined time (S850).

This is performed through the first sensing unit 200 and the control unit 150. If the door is not closed, the procedure is completed after predetermined time (for example, 10 seconds).

If the door is closed in step S850, after predetermined time (S870), the control unit 150 controls the driving unit 180 to lock the doorlock 190 (S880). According to the control of the control unit 150, the voice generating unit 170 outputs a 4th message (see FIG. 6, “door close”) (S890). The control unit 150 controls the voice generating unit 170 to output a 9th message (see FIG. 6, “No. 1 is record, No. 2 is cancel) (S900). When predetermined time (for example, 10 seconds) passes (S910), the procedure is completed. If not so, it is checked what key is pressed (S920). If No. 3 key is pressed, the procedure is completed.

If No. 1 key is pressed, the voice generating unit 170 outputs a No. 2 message (see FIG. 6, “speak”) according to the control of the control unit 150 (S930). The message of a going-out person is recorded for predetermined time (for example, 10 seconds) (S940). The message recoding steps are now described. For example, the message will be stored in the first storing means 130 under the control of the voice analyzing unit 120. After a 10th message (see FIG. 6, “enter key is end, No. 2 key is replay, and No. 3 key is cancel”) is outputted (S950), it is checked what key is pressed (S960). This is performed through the control unit 150. If the enter key is pressed, the procedure is completed. If the No. 3 key is pressed, after a 20th message (see FIG. 6, “cancelled”) is outputted (S980), this routine advances to step S900. If the No. 2 key is pressed, the recording content is replayed (S970) and this routine advances to step S900.

While the present invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

### INDUSTRIAL APPLICABILITY

According to the authentication procedure of the invention, the security of a home or office can be guaranteed. Further, the inconvenience of carrying a key such as mechanical doorlock and the apprehension of divulging a doorlock password are attenuated to enhance the security of a home or office.

Since an interphone function is offered to respond to the visit of outside visitors, the immediate response is not needed. Further, complex interconnection is removed to achieve a beautiful appearance and meet a user's desire. Due to the interphone function, visitors can record their messages.

Since a family message recording function is offered, the convenience of a user in a home or office is promoted to transmit a message to be transmitted to the next user or a message recorded by an outside visitor while he/she is absent. Thus, user's desire can be satisfied.

What is claimed is:

1. A voice recognition doorlock apparatus comprising:
first input means, having a plurality of input keys, for outputting input key signals corresponding to the input keys whenever the input keys are pressed;
second input means for receiving an analog voice signal and converting the received analog voice signal to a digital voice signal;
voice analyzing means for receiving the digital voice signal to extract a specific voice signal from the digital voice signal in a registration mode and storing the extracted specific voice signal in first storing means as an ID of a registration-desiring user;
control means for storing input key signals which is inputted through the first input means in the registration mode and indicates a password; and
doorlock driving means for locking or unlocking a doorlock according to the control of the control means,
wherein the voice analyzing means determines whether a currently inputted digital voice signal matches the specific voice signal stored in the first storing means to generate a first flag signal, as a determining result;
wherein when the currently inputted voice signal matches the specific voice signal stored in the first storing means, the control means determines whether the input key signals currently inputted as the password matches the input key signals stored in the second storing means in response to the first flag signal; and
wherein when the currently input key signals matches the input key signals stored in the second storing means, the control means control the door lock to be unlocked by the doorlock driving means.

2. The voice recognition doorlock apparatus of claim 1, further comprising:
voice generating means for generating a voice signal according to the control of the control means; and
first sensing means for sensing an open/close state of a door and transmitting the sensing result to the control means.

3. The voice recognition doorlock apparatus of claim 1, wherein a part of the input keys are disposed outside a door and the other input keys are disposed inside the door.

4. The voice recognition doorlock apparatus of claim 1, further comprising:
second sensing means for sensing an illegal handling of the input keys disposed inside the door and transmitting the sensing result to the control means.

5. The voice recognition doorlock apparatus of claim 4, wherein when the input keys disposed inside the door are not illegally handled by a person, the control means controls the voice generating means to output a warning sound in response to the sensing result transmitted from the second sensing means.

6. The voice generating doorlock apparatus of claim 5, wherein the voice analyzing means includes a dual tone multi-frequency (DTMF) generator; and
wherein when the control means generates a second flag signal indicating that the door is forcibly opened, the DTMF generator generates a MTMF signal.

7. The voice recognition doorlock apparatus of claim 6, further comprising radio transmitting means for transmitting the DTMF signal.

8. The voice recognition doorlock apparatus of claim 2, wherein the input keys include an interphone key; and
wherein when the interphone key is pressed, the control means controls the voice generating means to enable a user to output a predetermined voice message signal.

9. The voice recognition doorlock apparatus of claim 8, wherein when the interphone key is pressed, the control means controls the voice analyzing means, the voice generating means, and the first input means to enable the user to a message.

10. The voice recognition doorlock apparatus of claim 9, wherein the input keys include a record key; and
wherein when the record key is pressed, the control means controls the voice analyzing means, the voice generating means, and the first input means to enable the user to a message.
